(19) United States
(12) Patent Application Publication
(10) Pub. No.: US 2008/0124958 A1
(43) Pub. Date: May 29, 2008

(54) Electrical card connector

(75) Inventor: Yung-Chang Cheng, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/986,925

(22) Filed: Nov. 26, 2007

(30) Foreign Application Priority Data
Nov. 24, 2006 (CN) 200620125812.X

(51) Int. Cl. H01R 4/66; H01R 13/62

(52) U.S. Cl. 439/108; 439/155

(57) ABSTRACT

An electrical card connector (100) includes an insulated housing (2) and a metal shield (1). The insulated housing forms a plurality of passageways. A plurality of aligned terminals (3) are received in the passageways. The metal shield shields over the insulated housing and forms a card receiving room. The metal shield includes a top shell (11) and a pair of side walls (12), and a card inserting port is defined thereby. A plurality of grounding portions (112) are formed close to the card inserting port.

### BACKGROUND OF THE INVENTION

1. Field of the Invention

The present invention relates generally to an electrical card connector, and particularly to an anti-electrostatic electrical card connector.

2. Description of Related Arts

With a digital development of the electric technology, removable electric products that are taken away with people themselves, such as Personal Digital Assistants (PDA), Digital Still Cameras (DSC) or etc, are more and more popular. The electric product requires an electrical card for storing message, and then transferring information between the electric product and another one. Such kind of card with rapider accessing speed and lower electricity is more and more used and becomes a standard in an electric field.

An electrical card connector is usually assembled on a PCB of an electric product, and a card forms a plurality of metal pads electrically contacting with the electrical card connector to make sure that signals are transferred between the card and the PCB by the electrical card connector. Usually, electrostatic charges have already accumulated on the electrical card when the card begins to enter into the electrical card connector. If not properly discharged, when the card is inserted into and electrically contacts with the electrical card connector, a transient current buildup may damage a chip formed on the PCB. PCMCIA (Personal Computer Memory Card International Association) has regulated a grounding piece on a back and lateral wall of the card, and the electrical card connector forms a corresponding grounding element, so, when the card is fully inserted into the card connector, electrostatic charges are prevented from damaging to the chip of the PCB. However, two kinds of electrical cards are found in the market: one electrical card is that the whole lateral wall is made of metal material, and the other kind of electrical card is that only the grounding piece regulated by PCMCIA is made of metal material while other parts of the lateral walls are made of rubber. When the first kind of the electrical card is mated with the electrical card connector, electrostatic charges accumulated on the electrical card can be timely discharged; when the second kind of the electrical card is mated with the electrical card connector, before the grounding piece contacts with the grounding element, electrostatic charges accumulated on the electrical card will not be effectively discharged, so, a transient current is still existed to damage to the chip of the PCB when the card is fully inserted into the card connector.

Hence, an improved electrical card connector is desired.

### SUMMARY OF THE INVENTION

Accordingly, an object of the present invention is to provide an effectively anti-electrostatic electrical card connector, which can effectively discharge electrostatic charges when an electrical card, whose lateral walls are made of rubber except for the grounding piece regulated by PCMCIA, is inserted.

To achieve the above object, an electrical card connector includes an insulated housing and a metal shield. The insulated housing forms a plurality of passageways with a plurality of aligned terminals received therein. The metal shield shields over the insulated housing and forms a card receiving room. The metal shield includes a top shell and a pair of side walls, and a card inserting port is defined thereby. A plurality of grounding portions are formed close to the card inserting port.

Other objects, advantages and novel features of the invention will become more apparent from the following detailed description when taken in conjunction with the accompanying drawings.

### BRIEF DESCRIPTION OF THE DRAWING

FIG. 1 is a perspective, exploded view of an electrical card connector in accordance with the present invention and an electrical card which is inserted therein;

FIG. 2 is a view similar to FIG. 1, but taken from a different aspect; and

FIG. 3 is a perspective, assembled view of the electrical card connector and the electrical card.

### DETAILED DESCRIPTION OF THE PREFERRED EMBODIMENT

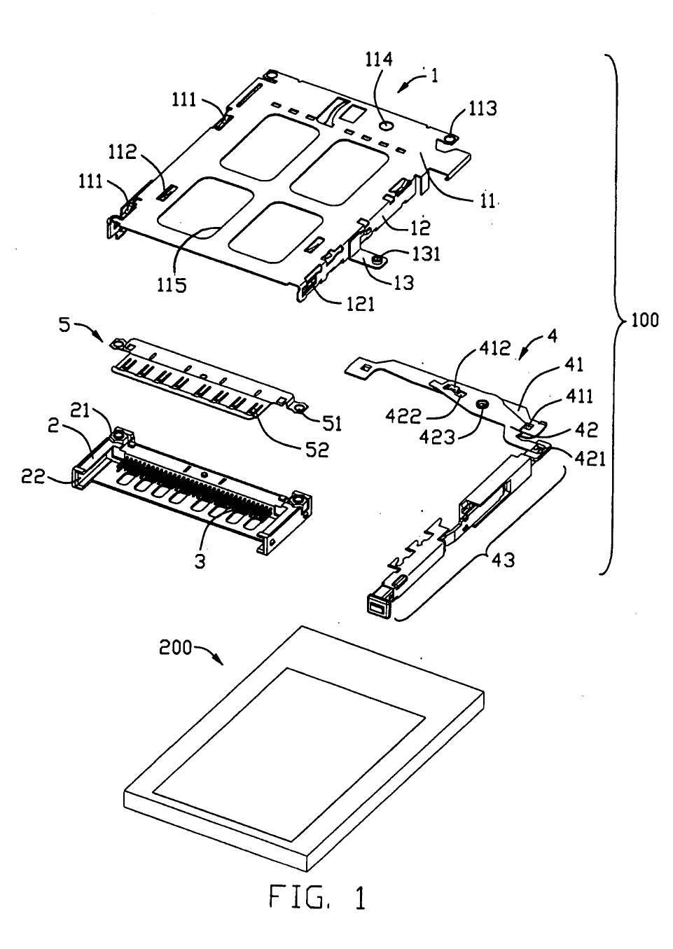

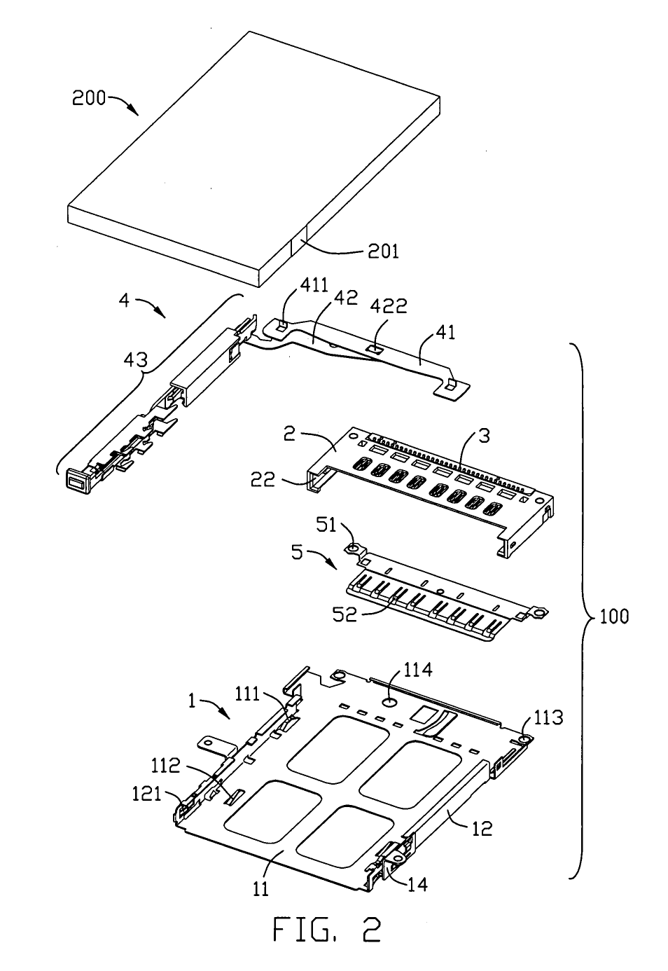

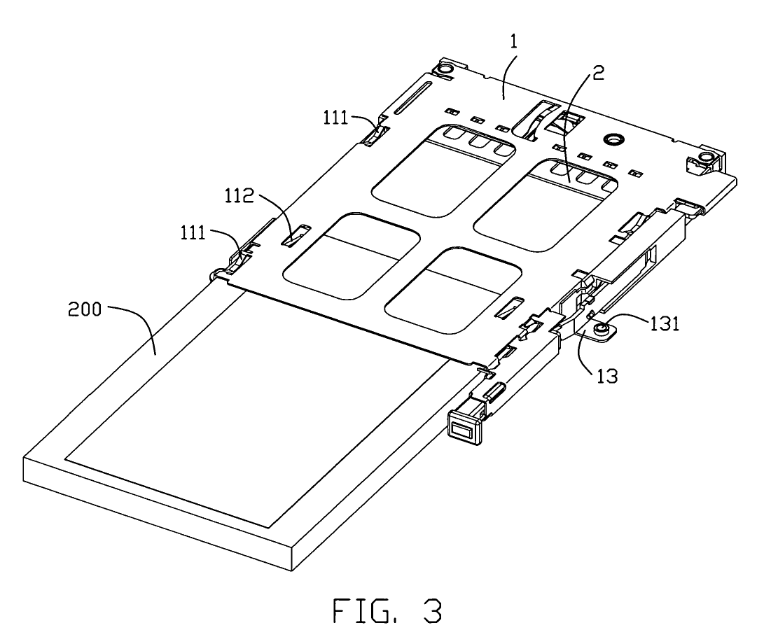

Referring to FIGS. 1-3, an electrical card connector 100 comprises a metal shield 1, an insulated housing 2, a plurality of terminals 3 received in the insulated housing 2, an ejector 4 assembled at the side of the insulated housing 2 and a grounding board 5 formed between the metal shield 1 and the insulated housing 2. An electrical card 200, which is inserted into the electrical card connector 100, comprises a top surface (not labeled) and a pair of lateral walls (not labeled). The top surface is made of metal material. The lateral walls form a pair of grounding pieces 201, which is regulated by the PCMCIA. The lateral walls are made of rubber material except that the grounding pieces 201 are made of metal material.

The metal shield 1 comprises a top shell 11 and two side walls 12 forming a card receiving room (not labeled) and a card inserting port (not label). Accordingly, we define one end far away from the card inserting port as a front end and the other end close to the card inserting port as a rear end. Of course, the terms “front” and “rear” are not meant to be limited but are descriptive according to the drawings. The side walls 12 form a pair of grounding elements 121 close to the card inserting port and correspond to the pair of grounding pieces 201. The top shell 11 forms a plurality of grounding portions 112 at the rear part thereof. The grounding portions 112 are used for timely discharging electrostatic charges accumulated on the electrical card 200 when the electrical card 200 begins to enter into the electrical card connector 100 and the grounding elements 121 are used for discharging electrostatic charges when the electrical card 200 is fully inserted into the electrical card connector 100. The top shell 11 forms a plurality of elastic pieces 111 at the rear part thereof for guiding the insertion of the electrical card 200. The elastic pieces 111 and the grounding portions 112 are both extending into the card receiving room, accordingly, both provide pressure to keep the electrical card 200 in touch with the insulated housing 2 closely. The top shell 11 defines a pair of first holes 113 at the front end thereof. The two first holes 113 are arranged along a transverse direction relative to a card inserting direction. A round hole 114 is formed on the top shell 11 and located between the two first holes 113. The metal shield 1 further comprises a pair of retaining plates 13, 14 assembled at the pair of side walls 12, for retaining the electrical card connector 100 on the PCB. The top shell 11 further intentionally forms a plurality of large sized through openings 115 which essentially occupy most area of the top shell 112 for heat dissipation consideration. Understandably, the size of the through openings 115 is defined by considering the factors of the effectiveness of heat transfer and the strength of the structures.

The insulated housing 2 comprises aligned passageways (not labeled), in which the terminals 3 are received. The aligned terminals 3 are arranged in two rows and one row is located above the other row. Each terminal 3 comprises a contacting portion (not labeled), a connecting portion (not labeled) and a soldering portion (not labeled), and the contacting portions extend into the card receiving room defined by the metal shield 1 and the insulated housing 2. The insulated housing 2 forms a receiving groove 22 at each side for guiding the insertion of the electrical card 200. At the front end of the insulated housing 2, there is a pair of screw nuts 21.

The grounding board 5 comprises a pair of second holes 51. In assembling, a pair of screws (not shown) in turn pass through the first holes 113, the second holes 51 and the screw nuts 21 to lock the three parts of the electrical card connector 100. The grounding board 5 further forms a plurality of spring pieces 52 pressing on the top shell 11 of the metal shield 1 to discharge electrostatic charges when the electrical card 200 is inserted into the electrical card connector 100 entirely.

The ejector 4 comprises a pushing lever 43 adjacent to one of the side walls 12 of the metal shield 1, an ejecting portion 41 located between the grounding board 5 and the metal shield 1 and an linking portion 42 connecting the pushing lever 43 with the ejecting portion 41. The linking portion 42 is also located between the grounding board 5 and the metal shield 1. The ejecting portion 41 comprises a protruding portion 411 at each end thereof and a hook 412 in the middle. The linking portion 42 comprises a locking portion 421 at one end, a slit 422 at the other one end and an axle 423 located between the locking portion 421 and the slit 422. The locking portion 421 engages with the pushing lever 43 and the slit 422 receives the hook 412 of the ejecting portion 41 so that the pushing lever 43, the linking portion 42 and the ejecting portion 41 combine as a whole. The slit 422 is large enough to make the hook 412 move therein. The axle 423 is received in the round hole 114 of the metal shield 1, and can rotate in the round hole 114. Accordingly, a user acts on the pushing lever 43, driving the linking portion 42 and the ejecting portion 41 to push the electrical card 200 out.

The invention has an advantage in that when the electrical card, whose lateral walls are made of rubber material except the grounding pieces which are regulated by PCMCIA, is inserted in the electrical card connector, the electrostatic charges accumulated on the electrical card can be discharged timely because of a plurality of grounding portions 112 formed at the rear part of the top shell 11. Accordingly, damages to a chip of the PCB can be avoided. It should be noted that the card 200 shown in the drawings is only to show the rough contour for general illustration. In fact, some type cards in practice have two recesses along two side edge regions so as to fit into the channels in two side walls 12. It means that the card defines a high plane occupying most of areas and a low plane only located on the side edge (periphery) region. The cantilever grounding portion 112 is intended not to press upon the low plane but the high plane. Therefore, the grounding portion 112 can not be located too close to the side edge of the top shell 11. On the other hand, for perform better balanced insertion/ejection, two grounding portions 112 transversely spaced from each other with sufficient distance is desired. On the other hand, most areas of the top shell 11 are occupied by the through openings 115. Based upon the foregoing factors, the positions of the pair of grounding portions 112, the dimensions/positions of the through openings 115 and the mutual location relationship therebewteen are somewhat delicate in design. In the present embodiment, each grounding portion 112 is expected to be spaced from the corresponding side wall 12 with a distance not less than one fifteenth of the whole transverse dimension of the top shell 11 so as to assure no risk for the grounding portion 112 to fall within the low plane area. On the other hand, in this embodiment the grounding portion 112 is not applied to the position around the center line for not jeopardizing the strength of the cross like structure which forms those four through openings 115.

While a preferred embodiment in accordance with the present invention has been shown and described, equivalent modifications and changes known to persons skilled in the art according to the spirit of the present invention are considered within the scope of the present invention as described in the appended claims.

I claim:

1. An electrical card connector, comprising:
an insulated housing forming a plurality of passageways and a plurality of aligned terminals received in the passageways;
a metal shield shielding over the insulated housing and defining a card receiving room and a card inserting port, the metal shield comprising a top shell and a pair of side walls, the top shell forming a plurality of grounding portions close to the card inserting port.

2. The electrical card connector as described in claim 1, wherein the top shell comprises a plurality of elastic pieces close to the card inserting port, and both the elastic pieces and the grounding portions extend into the card receiving room.

3. The electrical card connector as described in claim 1, further comprising a grounding board located between the metal shield and the insulated housing.

4. The electrical card connector as described in claim 3, wherein the metal shield and the grounding board both comprise a pair of holes, and the insulated housing comprises a pair of screw nuts, and a pair of screws pass through the holes in turn and screw onto the screws nuts.

5. The electrical card connector as described in claim 1, further comprising an ejector assembled at one side of the insulated housing.

6. The electrical card connector as described in claim 5, wherein the ejector comprises a pushing lever, an ejecting portion and a linking portion connecting the pushing lever with the ejecting portion.

7. The electrical card connector as described in claim 6, wherein the linking portion comprises a locking portion engaging with the pushing lever.

8. The electrical card connector as described in claim 7, wherein the linking portion comprises a slit and the ejecting portion comprises a hook received in the slit.

9. The electrical card connector as described in claim 8, wherein the metal shield comprises a round hole and the linking portion comprises an axle received in the round hole.

10. The electrical card connector as described in claim 1, wherein the aligned terminals are arranged in two rows and one row is located above the other row.

11. The electrical card connector as described in claim 10, wherein each terminal comprises a contacting portion, a connecting portion and a soldering portion and the contacting portions extend into the card receiving room.

12. An electrical card connector comprising:
an insulative housing;
a plurality of contacts disposed in the housing;
a metallic shell assembled to the housing, said shell including a large main plate and two side walls extending from two opposite side edges of the main plate, said shell cooperating with the housing to define a card receiving space adapted to receive a card in a front-to-back direction;
at least one through opening formed in the main plate; and
a pair of spaced resilient grounding portions unitarily extending from the main plate toward the card receiving space; wherein
each of said grounding portions is cantilevered and is spaced from either side wall of the shell with a distance not less than one fifteenth of a whole dimension of said shell in a transverse direction perpendicular to said front-to-back direction.

13. The card connector as claimed in claim 12, wherein said pair of grounding portions are essentially located on two side areas of the main plate.

14. The card connector as claimed in claim 13, wherein there are four said through openings formed by a cross like structure, and neither one of said grounding portions is located on said cross like structure.

15. The card connector as claimed in claim 12, wherein said shell is essentially symmetric with regard to a center line which generally equally divides said whole dimension of the shell along said transverse direction, and said pair of grounding portions are symmetrically arrangement with each other with regard to said center line.

16. The card connector as claimed in claim 12, wherein said pair of grounding portions are essentially located on two side regions of the shell.

17. An electrical card connector comprising:
an insualtive housing;
a plurality of contacts disposed in the housing;
a metallic shell assembled to the housing, said shell including a large main plate and two side walls extending from two opposite side edges of the main plate, said shell cooperating with the housing to define a card receiving space adapted to receive a card in a front-to-back direction;
a set of through opening area formed in the main plate;
said shell being essentially symmetric with regard to a center line which generally equally divides said whole dimension of the shell along a transverse direction perpendicular to the front-to-back direction; and
at least one cantilevered grounding portion unitarily extending from the main plate toward the card receiving space; wherein
said through opening area occupies most areas of the main plate.

18. The card connector as claimed in claim 17, wherein said grounding portion is essentially located on a side region of the main plane while is not located too close to the side wall but with a distance not less than one twentieth of a whole dimension of the main plate in said transverse direction.
